(19) United States
(12) Patent Application Publication
(10) Pub. No.: US 2013/0158739 A1
(43) Pub. Date: Jun. 20, 2013

(54) DATA COLLECTION AND COMMUNICATION SYSTEM FOR WATERBORNE VEHICLE

(71) Applicant: LARRY C. WILKINS, Ft. Lauderdale, FL (US)

(72) Inventor: LARRY C. WILKINS, Ft. Lauderdale, FL (US)

(21) Appl. No.: 13/687,513

(22) Filed: Nov. 28, 2012

Related U.S. Application Data
(60) Provisional application No. 61/563,971, filed on Nov. 28, 2011.

(51) Int. Cl. H04L 29/08; B65G 67/60

(52) U.S. Cl. CPC H04L 67/12; B65G 67/60
USPC 701/1; 414/803; 709/217

(57) ABSTRACT

A system for collecting and communicating data associated with a waterborne vehicle, includes at least one sensor configured to provide signals indicative of data associated with a parameter related to a waterborne vehicle. The system further includes a communication module configured to receive the signals and communicate with a user interface located remote from the vehicle. A method for loading material onto a waterborne vehicle, includes conveying material onto the waterborne vehicle. The method further includes monitoring the draft of the waterborne vehicle using at least one sensor, and discontinuing conveying the material onto the waterborne vehicle when the draft of the waterborne vehicle reaches a predetermined draft as indicated by the at least ore sensor.

### CROSS-REFERENCE TO RELATED APPLICATIONS

This application claims the benefit of priority under 35 U.S.C. §119(e) of U.S. Provisional Application No. 61/563,971 filed Nov. 28, 2011, the disclosure of which is incorporated herein by reference in its entirety.

### FIELD OF THE DISCLOSURE

The present disclosure relates to a data collection and communication system for waterborne vehicles, in particular, a data collection and communication system for waterborne vehicles including one or more sensors and a communication module for receiving and transmitting data associated with the waterborne vehicle.

### BACKGROUND

Waterborne vehicles may include, for example, boats, ships, submersibles, and barges, and it may be desirable to collect data associated with the waterborne vehicle and provide access to the data at a remote location. For example, it may be desirable to collect data associated with a barge and provide access to the data from a remote location. However, barges may typically not include their own source of power or an operator associated with a particular barge. This may render it difficult to determine the location or status of a particular barge, for example, whether a particular barge is loaded or unloaded. It may also be difficult to determine the draft of a particular barge while the barge is being loaded. Therefore, it may be desirable to provide a system for collecting data associated with a waterborne vehicle and/or for providing access to the collected data from a remote location.

### SUMMARY

In the following description, certain aspects and embodiments will become evident. It should be understood that the aspects and embodiments, in their broadest sense, could be practiced without having one more features of these aspects and embodiments. It should be understood that these aspects and embodiments are merely exemplary.

One aspect of the disclosure relates to a system for collecting and communicating data associated with a waterborne vehicle. The system includes at least one sensor configured to provide signals indicative of data associated with a parameter related to a waterborne vehicle. The system further includes a communication module configured to receive the signals and communicate with a user interface located remote from the waterborne vehicle.

According to another aspect, the parameter includes at least one of the location of the waterborne vehicle, draft of the waterborne vehicle, a load carried by the waterborne vehicle, whether the waterborne vehicle has collided with another object, whether fluid is located in wing voids of the waterborne vehicle, current and/or historical pressure in product tanks of the waterborne vehicle, current and/or historical vacuum in product tanks of the waterborne vehicle, current and/or historical temperature in product tanks of the waterborne vehicle, humidity in the product tanks of the waterborne vehicle, ambient temperature associated with the waterborne vehicle, ambient pressure associated with the waterborne vehicle, and ambient humidity associated with the waterborne vehicle.

According to still another aspect, the communication module is self powered. According to some aspects, the power for the communication module is supplied via at least one of a rechargeable battery, solar power, wind power, and water current power.

According to yet another aspect, the user interface facilitates viewing of data associated with the waterborne vehicle. The communication module is coupled to the user interface via one or more of the following: a hard-wired link, wireless link, a communications tower, a communications satellite, and an Internet connection. According to another aspect, the user interface includes a website. In another aspect, access to the website is password protected.

According to still another aspect, the user interface includes at least one of a computer and mobile computer. In another aspect, the mobile computer includes a smart phone.

According to yet another aspect, the system is configured to determine the draft of the waterborne vehicle at at least one location associated with the waterborne vehicle. In another aspect, the system is configured to determine the draft of the waterborne vehicle at at least two locations associated with the waterborne vehicle. In still another aspect, the system is configured to determine the draft of the waterborne vehicle at at least three locations associated with the waterborne vehicle. In yet another aspect, the system is configured to determine the draft of the waterborne vehicle at at least four locations associated with the waterborne vehicle.

According to still another aspect, the at least one sensor comprises a pressure sensor.

According to still another aspect, the communication with the user interface includes a cellular message.

According to still another aspect, a device associated with the user interface is configured to compare a value based on the signals indicative of data associated with the perimeter with a predetermined set point value. The device associated with the user is further configured to output at least one of a warning and an alarm if the comparison satisfies a predetermined criterion.

According to another aspect, a method for loading material onto a waterborne vehicle includes conveying material onto the waterborne vehicle. The method further includes monitoring the draft of the waterborne vehicle using at least one sensor, and discontinuing conveying the material onto the waterborne vehicle when the draft of the waterborne vehicle reaches a predetermined draft as indicated by the at least one sensor.

According to yet another aspect, a waterborne vehicle includes a hull and a system coupled to the hull. The system is configured to collect and communicate data associated with the waterborne vehicle. The system includes at least one sensor configured to provide signals indicative of data associated with a parameter related to the waterborne vehicle, and a communication module configured to receive the signals and communicate with a user interface located remote from the waterborne vehicle.

According to another aspect, thee waterborne vehicle is a barge.

Potential objects and advantages of the exemplary embodiments will be set forth in part in the description which follows, or may be learned by practice of the exemplary embodiments. It is to be understood that both the foregoing general description and the following detailed description are exemplary and explanatory only and are not restrictive of the invention. The accompanying drawings and attachment, which are incorporated in and constitute a part of this specification, illustrate several exemplary embodiments and together with the description, serve to outline principles of the exemplary embodiments.

### BRIEF DESCRIPTION OF THE DRAWINGS

FIG. 1A is a schematic top view of an exemplary embodiment of waterborne vehicle, including portions of an exemplary embodiment of a system for collecting data associated with the waterborne vehicle.

FIG. 1B is a detailed view of a portion of FIG. 1A.

FIG. 2A is a schematic side view of the exemplary embodiment shown in FIG. 1.

FIG. 2B is a detailed view of a portion of FIG. 2A.

FIG. 3 is a schematic diagram of an exemplary embodiment of a system for collecting and communicating data associated with a waterborne vehicle to a remote location.

FIG. 4 is a schematic diagram of an exemplary embodiment of a system for collecting and communicating data associated with a waterborne vehicle a remote location.

FIG. 5A is an isometric view of an exemplary embodiment of a pressure sensor.

FIG. 5B a top view of the exemplary pressure sensor of FIG. 5A.

FIG. 5C is a cross-section view taken along line A-A of FIG. 5B.

FIG. 5D is a top-section view taken along line B-B of FIG. 5C.

FIG. 6A is an exemplary embodiment of information relating to the draft of an exemplary vehicle at locations associated with exemplary sensors when the vehicle is unloaded.

FIG. 6B is an exemplary embodiment of information relating to the draft of the vehicle shown in FIG. 6A when the rear portion of the vehicle is loaded.

FIG. 6C is an exemplary embodiment of information relating to the draft of the vehicle shown in FIG. 6A when the rear and center portions of the vehicle are loaded.

FIG. 6D is an exemplary embodiment of information relating to the draft the vehicle shown in FIG. 6A when the vehicle is fully loaded.

### DESCRIPTION OF EXEMPLARY EMBODIMENTS

Reference will now be made to exemplary embodiments of the invention, which are illustrated in the accompanying drawings. Wherever possible, the same reference numbers will be used throughout the drawings to refer to the same or like parts.

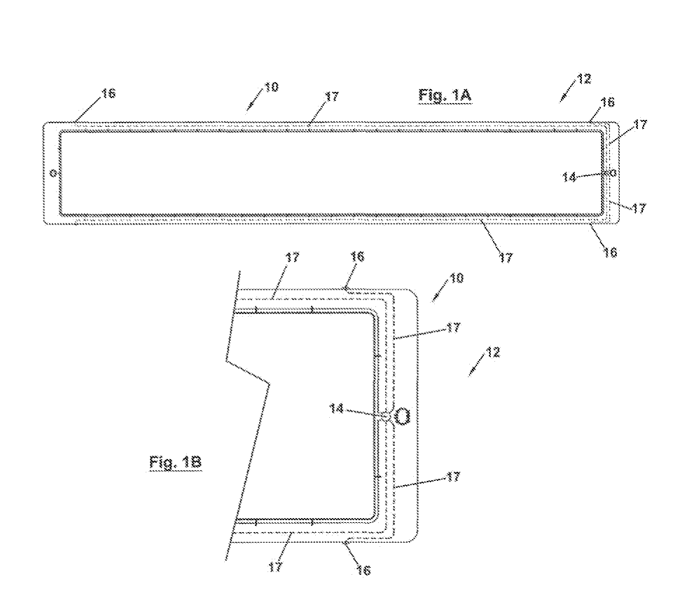

FIG. 1 shows an exemplary embodiment of a waterborne vehicle 10. Exemplary vehicle 10 shown in FIG. 1 is a barge. However, vehicle 10 could be any type of vehicle configured to travel in water, such as, for example submersibles, ships, and boats.

Vehicle 10 shown in FIG. 1 includes on exemplary embodiment of a system 12 for collecting data associated with vehicle 10 and providing access to the collected data from a remote location. Such data may be related to parameters associated with vehicle 10 and may include, but is not limited to, the location of vehicle 10, the draft of vehicle 10 (e.g., the depth of vehicle 10 submerged below the surface of the water in which vehicle 10 floats), the weight of material carried by vehicle 10, whether fluid is located in wing voids of vehicle 10 (e.g., when vehicle 10 is barge having wing voids), whether vehicle 10 has collided with an object, pressure (current and/or historical) in product tanks of vehicle 10, vacuum (current and/or historical) in product tanks, temperature (current and/or historical) in product tanks, humidity in product tanks, and/or ambient temperature, pressure, and/or humidity associated with vehicle 10.

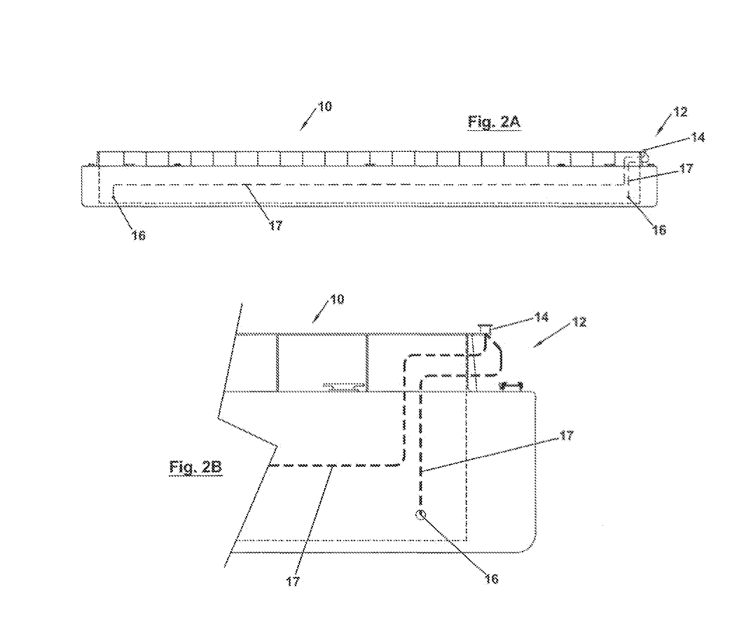

As shown in FIGS. 1A and 1B, exemplary system 12 includes a communication module 14 and a plurality of sensors 16. As shown in FIGS. 1A, 1B, 2A, and 2B, sensors 16 are linked to communication module 14 via a communications link 17, such as, for example, a hardwired- and/or wireless-link. Communication module 14 is configured to receive signals from sensors 16 and communicate information related to the signals to a remote location.

A remote location may include any place remote from a sensor associated with vehicle 10, including, such as, for example, a location aboard vehicle 10 separated from the sensor, dockside relative to vehicle 10, in an office located at a port, aboard a boat in the vicinity of vehicle 10 such as a tugboat, and anywhere linked to system 12 wirelessly or via hardwired communication link, such as, for example, an office located anywhere the world. According to some embodiments, a remote location may be a fixed location, such as a terminal or display unit aboard vehicle 10, on the dockside relative to vehicle 10, an office located at a port, or on board a boat in the vicinity of vehicle 10. According to some embodiments, a remote location may be a mobile device such as a cellular or mobile telephone (e.g., a smart phone), a tablet computer, or a laptop or mobile computer.

Communication module 14 may be mounted anywhere on vehicle 10, for example, at a location where the communication module 14 may be exposed to sunlight and may facilitate wireless communication to a location remote from vehicle 10. According to some embodiments, communication module 14 may include structures configured to convert solar energy into power sufficient to supply electricity to communication module 14 for its operation. According to some embodiments, communication module 14 may include a battery (e.g., a rechargeable lithium-ion battery, configured to store electricity provided by solar energy. According to some embodiments, power may be supplied to communication module 14 via transformation of wind power to electric power and/or transformation of water current to electric power. Other sources of electric power are contemplated, such as fuel cells.

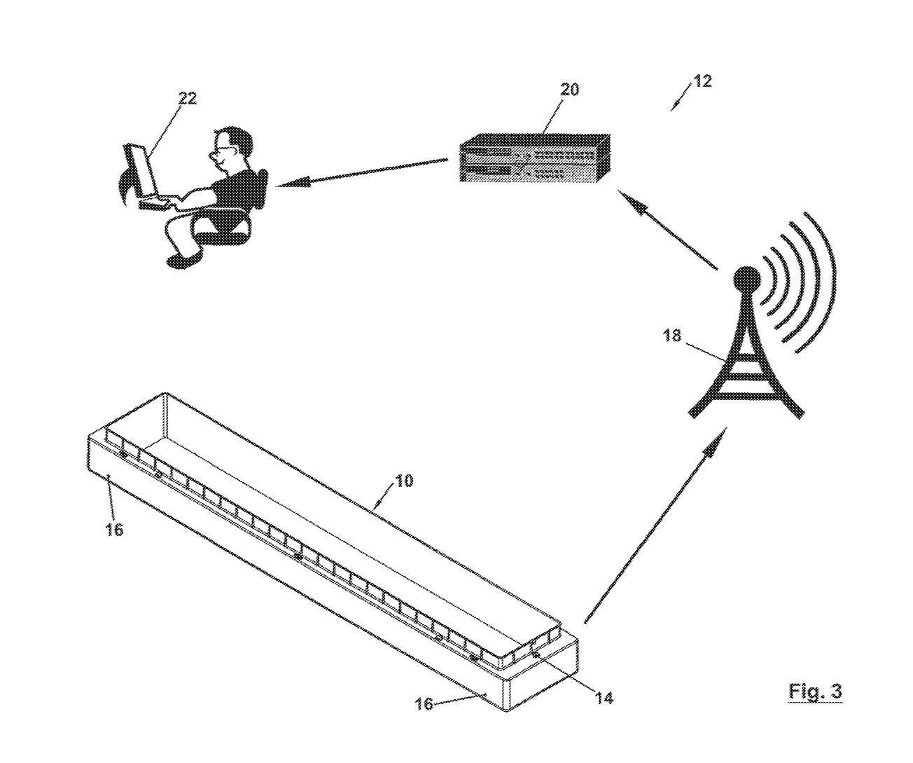

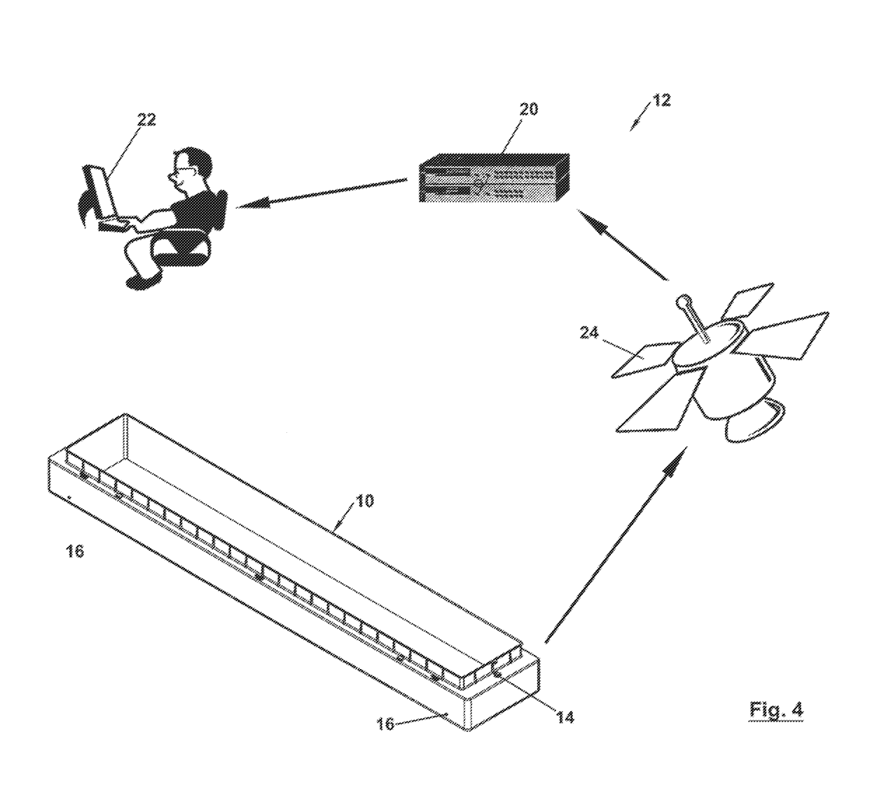

As shown in FIGS. 3 and 4, communication module 14 is configured to send signals providing data based on the signals received from the plurality sensors 16 to a remote location. For example, communication module 14 may be configured to be coupled via hardwire to a communications link, such as a local network or to the Internet. As shown in FIG. 3, according to some embodiments, communication module 14 may be configured to send signals via wireless link to a communications tower 18 (e.g., a cell tower), which, in turn, may forward the communication to an intermediate device 20, such as a mobile device (e.g., such as a mobile computer or smart phone), and/or a stationary device (e.g., such as a server computer), which, in turn, may forward the communication to a user interface 22, such as, for example, a mobile device, such as a mobile computer or smart phone, and/or a computer terminal, such as a stationary or laptop computer.

As shown in FIG. 4, communications tower 18 may be replaced or supplemented by, fore ample, a communications satellite 24. It is contemplated that one or more of communication tower 18, intermediate device 20, and/or communication satellite 24 may be omitted, replaced, or supplemented by other device(s) to facilitate communications between communication module 14 and user interface 22.

According to some embodiments, user interface 22 may facilitate access to data associated with vehicle 10 communicated by communication module 14. For example, the data may be received and posted on a website, and access to the website and data may be facilitated, so that a person remote from vehicle 10 may be supplied with the data. According to some embodiments, a data security system may be provided, which provides authorized personnel access to the data via the website, for example, via password-protection.

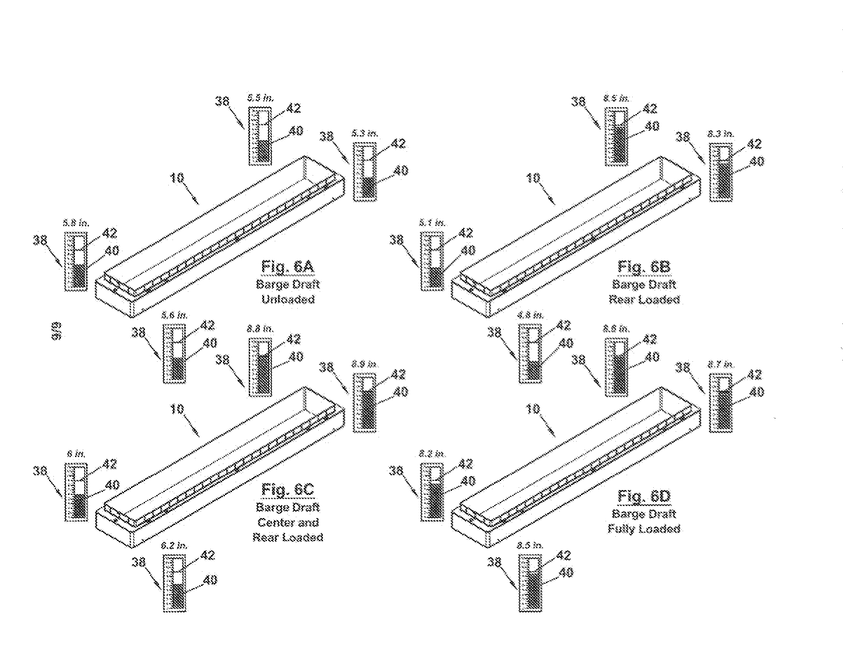

According to some embodiments, communication module 14 may send a cellular message or e-mail message to a mobile device via a cellular network, for example, a text message. It is contemplated that a cellular message may include a short message service (SMS) message. The cellular message may contain only text, only images, or a combination of images and text. An exemplary image message may be, for example, one or more of the images shown in FIGS. 6A-6D. Other cellular messages are contemplated.

According to some embodiments, system 12 may be configured to facilitate tracking of vehicle 10 using, for example, one or more sensors 16 and Global Positioning System information, inertial navigation system information that may make use of gyroscopic movement information or other information related to position and movement. Communication module 14 may facilitate such tracking by sending communication signals to user interface 22 and providing access to the data, for example, as described above. For example, communication module 14 may use Global Positioning System information to send the latitude and longitude of vehicle 10 to a remote location as part of the communication signals. Communication module 14 may also, for example, use Global Positioning System information to calculate the speed and/or direction of vehicle 10 and communicate this information to a remote location. It is contemplated that the Global Positioning System information may be used to identify the location of vehicle 10 on a map, and one of communication module 14 or a device at a remote location may create a map image showing the location of vehicle 10.

According to some embodiments, system 12 may be configured to provide information relating to the draft of vehicle 10. For example, system 12 may include one or more sensors 16, which may be configured to provide information relating to how deep vehicle 10 is sitting in the water (i.e., the distance between the bottom of vehicle 10 and the surface of the water in which vehicle 10 is floating). For example, system 12 may include a first sensor 16 located at a first end of vehicle 10 and a second sensor 16 located a second end of vehicle 10 located opposite the first end. For example, vehicle 10 may define four corners, and system 12 may include one or more sensors 16 located at each of the four corners of vehicle 10. The provision of fewer than four sensors is contemplated. For example, a single sensor 16 could be located at a central location of vehicle 10, with the centrally-located sensor 16 being configured to provide information relating to how deeply vehicle 10 is sitting in the water at the central location. It is also contemplated that a single sensor 16 may include a device, such as a level, to determine whether vehicle 10 is tilted such that it sits unevenly in a body of water, and to calculate the draft at each edge or corner of vehicle 10 either in addition to, or in place of, the draft at the central location.

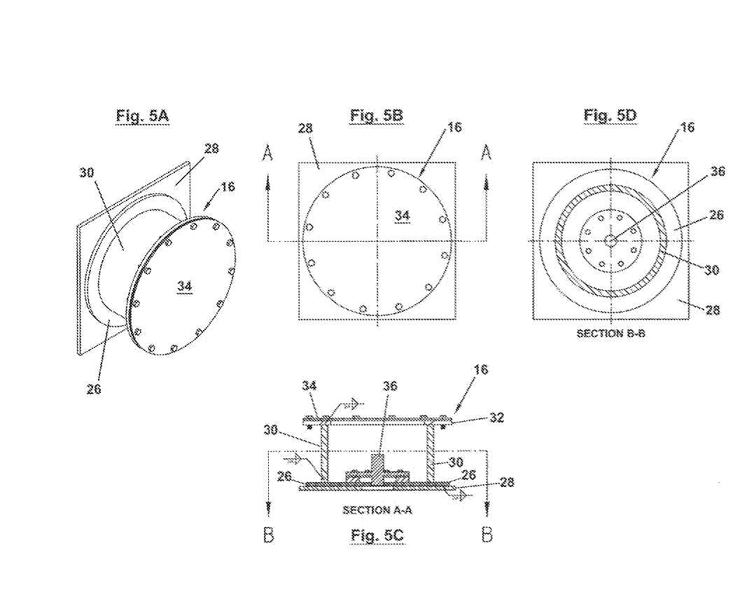

In the exemplary embodiment shown in FIGS. 1A and 1B, system 12 includes four sensors 16, each located adjacent four corners of vehicle 10. According to some embodiments, one or more (e.g., each) of sensors 16 is a pressure sensor configured to sense pressure and send signals indicative of pressure to communication module 14. For example, FIGS. 5A-5D show various views of an exemplary pressure sensor 16 that may be used. System 12 may further include a sensor (not shown) for detecting ambient pressure in the vicinity of vehicle 10, and pressure signals from sensors 16 may be used to determine the depth below the surface of the water at the point at which sensors 16 are mounted on vehicle 10. By knowing the relative placement of the sensors 16 on vehicle 10 (i.e., the vertical location of the sensors 16 relative to the bottom of vehicle 10), the draft of vehicle 10, or the depth below the surface of the water of the bottom of vehicle 10, may be determined.

FIG. 5A shows an exemplary isometric view of an exemplary embodiment of a pressure sensor 16. FIG. 5B shows an exemplary top view of exemplary pressure sensor 16. FIG. 5C shows an exemplary cross-section view of exemplary pressure sensor 16 taken about line A-A of FIG. 5B. FIG. 5D shows to view taken along line B-B of FIG. 5C.

Exemplary pressure sensor 16 may include a shell base 26 configured to be coupled to vehicle housing 28. Vehicle housing 28 may be part of exemplary vehicle 10, such as the housing of a barge or other waterborne vehicle. Shell base 26 may be coupled to a shell wall 30 and a shell flange 32. Shell flange 32 may be coupled to a shell cap 34. According to some embodiments, shell base 26, shell wall 30, shell flange 32, and shell cap 34 may be formed by a single unitary structure formed from a single piece of material. According to some embodiments, shell base 26, shell wall 30, shell flange 32, and shell cap 34 may be formed by a plurality of structures which are coupled together. For example, shell base 26, shell wall 30, and shell flange 32 may be a single structure and shell cap 34 may be a separate structure coupled to shell flange 32. According to some embodiments, sensors 16 are waterproof. For example, according to some embodiments, shell flange and shell cap 34 are separated by a gasket to provide a waterproof seal. Exemplary pressure sensor 16 may also include a sensing device 36, such as draft sensor, to measure pressure. Sensing device 36 may send one or more signals via communications link 17 to communication module 14 for transmission to a remote location

According to some embodiments, sensor types other than pressure sensors may be used to determine the draft of vehicle 10. For example, float sensors in tubes may be used with proximity sensors, such as, for example, laser sensors and/or ultrasonic sensors, to determine the draft of vehicle 10. The use of other types of sensors is contemplated.

Exemplary sensors 16 may provide signals to communication module 14, and communication module 14 may be configured to determine the draft of vehicle 10 and send the draft information to a remote location, and/or to send the sensor signals to a remote location, where the draft may be determined remotely following receipt of the signals. For example, as shown in FIGS. 6A-6D, system 12 may be configured to provide information sufficient to determine the draft of vehicle 10 at a location associated with respective sensors 16. As shown in FIGS. 6A-6D, the draft information may be provided for each of four corners of four-cornered vehicle 10. It is contemplated that FIGS. 6A-6D are exemplary displays, such as the display of information on a user interface at a remote location.

FIG. 6A shows an exemplary embodiment of information relating to the draft of exemplary vehicle 10, such as when vehicle 10 is unloaded. According to some embodiments, gauges 38 display draft data 40 relating to vehicle 10 at the location of a respective sensor 16. According to some embodiments, gauges 38 are displayed on a visual display, such as a user interface, at a remote location. Gauges 38 may also include set points 42. According to some embodiments, when draft data 40 is equal to set point 42, warnings/alarms may be triggered, as described below. As shown in FIG. 6A, exemplary draft data 40 at each of four exemplary locations of vehicle 10 when vehicle 10 is unloaded are 5.5 inches, 5.3 inches, 5.8 inches, and 5.6 inches. FIG. 6B shows exemplary draft data 40 at the four exemplary locations when the rear portion of exemplary vehicle 10 has been loaded. The respective draft data 40 in FIG. 6B are shown to be, for example, 8.5 inches, 8.3 inches, 5,1 inches, and 4.8 inches. FIGS. 6C and 6D show the exemplary respective draft data 40 when the rear and center portions of vehicle 10 are loaded (FIG. 6C) and when vehicle 10 is fully loaded (FIG. 6D).

According to some embodiments, the visual display of draft data 40 may change as it approaches, is equal to, or is greater than the value of respective set points 42. For example, when draft data 40 is, for example, lower than set point 42 by one inch or more, draft data 40 may appear in a green color. When draft data 40 is, for example, lower than set point 42 by less than one inch, draft data 40 may appear, for example, in a yellow color. When draft data 40 is equal to or greater than set point 42, draft data 40 may appear, for example, in a red color. Other visual indicators are also contemplated. For example, draft data 40 may blink or flash when it is within a predetermined value of set point 42 and the rate of blinking or flashing may increase as draft data 40 approaches or exceeds the value of set point 42.

It may be desirable to determine the draft of vehicle 10 for a number of reasons. For example, such information may be useful when vehicle 10 is being loaded with cargo or material. As vehicle 10 is loaded, it will sink lower in the water. As a result, the draft will increase, particularly at portions of vehicle 10 more heavily loaded. In order ensure compliance with regulations and/or in prevent vehicle 10 from being overloaded or unevenly loaded, it may be desirable to determine the draft as vehicle 10 is being loaded. In some embodiments, this determination may be performed real-time, and automatically and advantageously provide real-time feedback (e.g., warnings) via a user interface. In particular, some regulations may specify the maximum draft of a waterborne craft permitted on a particular body of water (e.g., a canal, river, or lake, etc.). Thus, the ability to determine the draft real-time as vehicle 10 is being loaded may result in loading vehicle 10 with more cargo or material, while still maintaining compliance with such draft regulations. In addition, it may be desirable to know the draft during loading in order to ensure that vehicle 10 is not overloaded for the body of water on which vehicle 10 will be navigating, or to ensure that vehicle 10 is loaded evenly. It may also be desirable to now the draft to prevent overloading of vehicle 10, which may prevent vehicle 10 from striking obstacles during transit.

According to some embodiments, system 12 may include one or more sensors 16 configured to provide signals for determining one more of the following: the weight of material carried by vehicle 10, whether fluid is located in wing voids of vehicle 10 (e.g., when vehicle 10 is a barge having wing voids), whether vehicle 10 has collided with something (e.g., using accelerometer(s)), pressure (current and/or historical) in product tanks of vehicle 10, vacuum (current and/or historical) in product tanks, temperature (current and/or historical) in product tanks, humidity in product tanks, and/or ambient temperature, pressure, and/or humidity associated with vehicle 10. The information from these sensors may be collected by communication module 14, which may communicate this data to other systems, which may, in turn, use the data to take action responsive to the data. For example, based on the data, warnings/alarms may be triggered alerting the desirability of responsive action. For example, the sensors may sense the data, the communication module may communicate the data real-time to a user interface, resulting in a real-time warning/alarm, for example, about the vehicle colliding with another body.

According to some embodiments, the device at a remote location may include a visual display. The visual display may display information based on the signals from sensors 16 and communicated by communication module 14. According to some embodiments, set points 42 are not displayed visually, but are used to compare the data and signals received from sensors 16 and/or transmitted by communication module 14. An exemplary display is described above with reference to FIGS. 6A-6D. The display may include set points 42, such as a specific location in a Global Positioning System, or a minimum/maximum draft, load, pressure, vacuum, temperature, acceleration, fluid level in wing voids, and/or humidity. Set points 42 may be manually entered by a user, or may be manually or automatically loaded from a database, for example, based on a scheduled transportation route for vehicle 10 or a current or future body of water in which vehicle 10 is travelling.

According to some embodiments, set points 42 may be used to trigger warnings/alarms based on signals transmitted by communication module 14 and received from sensors 16. For example, a warning/alarm may be triggered when the data based on at least one of sensors 16 is within a specified range of set point 42. According to some embodiments, a warning alarm may be triggered when the data related to sensors 16 is within a specified range of set point 42, such as, for example, 1 inch of the maximum draft, 5 percent humidity, or 500 miles of a specific Global Positioning System coordinate. It is also contemplated that a warning/alarm may be triggered when the data related to sensors 16 is equal to a specified set point 42.

According to some embodiments, data related to sensors 16 is communicated by communication module 14 to a remote location where the data may be visually displayed on a device, for example, on a computer or mobile device, such as a smart phone. According to some embodiments, the device at the remote location may prompt a user for responsive action. For example, an application running on the device may allow the user to initiate a call to a specified individual, such as a foreman or supervisor loading vehicle 10. Other examples of a responsive action may include, for example, prompting the user to create a cellular message or e-mail message. It is contemplated that some or all of the cellular message or e-mail message may be automatically generated using the data that triggered the warning/alarm. Other responsive actions are also contemplated.

According to some embodiments, data related to sensors 16 and set points 42 is not directly communicated by communication module 14. For example, communication module 14 may send warnings/alarms to a remote location, which are based on the data related to sensors 16 and set points 42.

Other embodiments of the invention will be apparent to those skilled in the art from consideration of the specification and practice of the invention disclosed herein. It is intended that the specification and examples considered as exemplary only, with a true scope and spirit of the invention being indicated by the following claims.

What is claimed:

1. A system for collecting and communicating data associated with a waterborne vehicle, the system comprising:
at least one sensor configured to provide signal indicative of data associated with a parameter related to a waterborne vehicle; and
a communication module configured to receive the signals and communicate with a user interface located remote from the waterborne vehicle.

2. The system of claim 1, wherein the parameter comprises at least one of location of the waterborne vehicle, draft of the waterborne vehicle, a load carried by the waterborne vehicle, whether the waterborne vehicle has collided with another object, whether fluid is located in wing voids of the waterborne vehicle, current and/or historical pressure in product tanks of the waterborne vehicle, current and/or historical vacuum in product tanks of the waterborne vehicle, current and/or historical temperature in product tanks of the waterborne vehicle, humidity in the product tanks of the waterborne vehicle, ambient temperature associated with the waterborne vehicle, ambient pressure associated with the waterborne vehicle, and ambient humidity associated with the waterborne vehicle.

3. The system of claim 1, wherein the communication module is self-powered.

4. The system of claim 1, wherein power for the communication module is supplied via at least one of a rechargeable battery, solar power, wind power, and water current power.

5. The system of claim 1, further comprising the user interface to facilitate viewing of data associated with the waterborne vehicle.

6. The system of claim 5, wherein the communication module is coupled to the user interface via one or more of the following: a hard-wired link, a wireless link, a communications tower, a communications satellite, and an Internet connection.

7. The system of claim 5, term the user interface comprises a website.

8. The system of claim 7, wherein access to the website is password protected.

9. The system of claim 5, wherein the user interface comprises at least one of a computer and mobile computer.

10. The system of claim 9, wherein the mobile computer comprises a smart phone.

11. The system of claim 1, wherein the system is configured to determine the draft of the waterborne vehicle at at least one location associated with the waterborne vehicle.

12. The system of claim 11, wherein the system is configured to determine the draft of the waterborne vehicle at at least two locations associated with the waterborne vehicle.

13. The system of claim 11, wherein the system is configured to determine the draft of the waterborne vehicle at at least three locations associated with the waterborne vehicle.

14. The system of claim 11, wherein the system configured to determine the draft of the waterborne vehicle at at least four locations associated with the waterborne vehicle.

15. The system of claim 11, wherein the at least one sensor comprises a pressure sensor.

16. The system of claim 1, wherein the communication with the user interface comprises a cellular message.

17. The system of claim 1, wherein a device associated with the user interface is configured to compare a value based on the signals indicative of data associated with the parameter with a predetermined set point value.

18. The system of claim 17, wherein the device associated with the user interface is further configured to output at least one of a warning and an alarm if the comparison satisfies a predetermined criterion.

19. A method for loading material onto a waterborne vehicle, the method comprising:
conveying material onto the waterborne vehicle;
monitoring the draft of the waterborne vehicle using at least one sensor; and
discontinuing conveying the material onto the waterborne vehicle when the draft of the waterborne vehicle reaches a predetermined draft as indicated by the at least one sensor.

20. The method of claim 19, further comprising communicating a signal measured by the at least one sensor to a remote location using a communication module.

21. The method of claim 20, wherein communicating the signal includes communicating data related to the draft of the waterborne vehicle.

22. The method of claim 19, wherein monitoring the draft of the waterborne vehicle further comprises outputting at least one of a warning and an alarm when the draft of the waterborne vehicle is equal to or exceeds the predetermined draft.

23. The method of claim 19, wherein monitoring the draft of the waterborne vehicle includes using at least one pressure sensor to monitor the draft.

24. A waterborne vehicle comprising:
a hull; and
a system coupled to the hull, wherein the system is configured to collect and communicate data associated with the waterborne vehicle, the system comprising:
at least one sensor configured to provide signals indicative of data associated with a parameter related to the waterborne vehicle, and
a communication module configured to receive the signals and communicate with a user interface located remote from the vehicle.

25. The waterborne vehicle of clam 24, wherein the waterborne vehicle comprises a barge.

26. The waterborne vehicle of claim 24, wherein the parameter comprises at least one of location of the waterborne vehicle, draft of the waterborne vehicle, a load carried by the waterborne vehicle, whether the waterborne vehicle has collided with another object, whether fluid is located in wing voids of the waterborne vehicle, current and/or historical pressure in product tanks of the waterborne vehicle, current and/or historical vacuum in product tanks of the waterborne vehicle, current and/or historical temperature in product tanks of the waterborne vehicle, humidity in the product tanks of the waterborne vehicle, ambient temperature associated with the waterborne vehicle, ambient pressure associated with the waterborne vehicle, and ambient humidity associated with the waterborne vehicle.

27. The waterborne vehicle of claim 26, wherein the communication module is self-powered.

28. The waterborne vehicle of claim 26, wherein power for the communication module is supplied via at least one of a rechargeable battery, solar power, wind power, and water current power.

29. The waterborne vehicle of claim 24, further comprising the user interface to facilitate viewing of data associated with the waterborne vehicle.

30. The waterborne vehicle of claim 29, wherein the communication module is coupled to the user interface via one or more of the following: a hard-wired link, a wireless link, a communications tower, a communications satellite, and an Internet connection.

31. The waterborne vehicle of claim 29, wherein the user interface comprises a website.

32. The waterborne vehicle of claim 31, wherein access to the website is password-protected.

33. The waterborne vehicle of claim 29, wherein the user interface comprises at least one of a computer and mobile computer.

34. The waterborne vehicle of claim 33, wherein the mobile computer comprises a smart phone.

35. The waterborne vehicle of claim 24, wherein the system is configured to determine the draft of the waterborne vehicle at at least one location associated with the waterborne vehicle.

36. The waterborne vehicle of claim 35, wherein the system is configured to determine the draft of the waterborne vehicle at at least two locations associated with the waterborne vehicle.

37. The waterborne vehicle of claim 35, wherein the system is configured to determine the draft of the waterborne vehicle at at least three locations associated with the waterborne vehicle.

38. The waterborne vehicle of claim 35, wherein the system is configured to determine the draft of the waterborne vehicle at at least four locations associated the waterborne vehicle.

39. The waterborne vehicle of claim 35, wherein the at least one sensor comprises a pressure sensor.

40. The waterborne vehicle of claim 24, where in the communication with the user interface comprises a cellular message.

41. The waterborne vehicle of claim 41, wherein a device associated with the user interface is configured to compare a value based on the signals indicative of data associated with the parameter with a predetermined set point value.

42. The waterborne vehicle of clam 41, wherein the device associated with the user interface is further configured to output at least one of a warning and an alarm if the comparison satisfies a predetermined criterion.
